(19) United States
(12) Patent Application Publication
(10) Pub. No.: US 2006/0068878 A1
(43) Pub. Date: Mar. 30, 2006

(54) Roulette revenue method and apparatus

(75) Inventors: Peter Krenn, Neufeld (AT); Ernst Blaha, Tullnerbach (AT)

Correspondence Address: Mark A. Litman & Associates, P.A.;York Business Center, Suite 205, 3209 West 76th St., Edina, MN, 55435, US

(73) Assignee: Shuffle Master GmbH & Co KG

(21) Appl. No.: 10/953,900

(22) Filed: Sep. 29, 2004

(51) Int. Cl. G06F 19/00; G06F 17/00

(52) U.S. Cl. 463/17

(57) ABSTRACT

Multicolored casino wagering chips are assigned temporary values and those values are transmitted to a separate device, such as a chip sorter that is used to determine chip values and value flow during a casino table game. A single color chip is temporarily associated with a chosen value for that color chip, and the value/chip relationship is provided to all systems that use that relationship in assessing game performance, wins, losses, payouts, record keeping, and security for the table game. In one embodiment of the technology described herein, a set of opposed slots on a rack is provided, with a single color of chip and an electronic marker positioned on an opposed pair of slots. The marker sends out a signal regarding the temporary value of the color chip, and that sent value is used by all automated systems on or about the gaming table to assign value to that color chip. At the conclusion of play with a particular color of chip, all the chips are returned by the player, the chips repurchased, and the value is erased from the records for that particular chip. The markers and chips may be displayed on the rack for visual inspection during play.

### BACKGROUND OF THE INVENTION

1. Field of the Invention

The present invention relates to wagering game valuation systems for use at casino table games, and especially for use in roulette and roulette-type games. The invention further relates to valuation and tabulation of value wagered through chips or tokens used to wager at a casino, particularly to chips that may be temporarily assigned a value, and most narrowly to chips that may be used in the play of roulette.

2. Background of the Art

It has become important for wagering facilities such as casinos to monitor or account for wagering by individual tables, individual dealers and individual players.

In casinos, there are different types of chips that are used throughout the casino. Most chips are portable from one table to another, and come in standard denominations of, for example, $1, $5, $25, $100, $500, etc. The denominations of chips are differentiated by the alphanumerics on the chips and the color of the chips, particularly their edges and faces. Traditional colors for the chips are $1 white or silver, $5 red, $25 green, $100 black, $500 purple, etc. A problem has always existed in the use of a uniform supply of chips in certain table games. In craps, players' wagers are precisely placed at specific betting locations. The bets are typically positioned on the wagering areas of the layout and watched by the players to confirm their location.

The problem of chip placement is more complex in bet placement with a roulette system, as the surface area/wager is significantly smaller, and many of the wagers immediately abut or cross into the wagering space of other possible bets. This problem has been traditionally addressed by providing chips of different colors (but with a uniform value for each color) to each player. This has worked fairly well over the years, but with the use of more electronics on gaming tables, this antiquated system has shown some significant weaknesses.

One major weakness is that in roulette, the value of a particular color chip must remain the same during play. Otherwise play must stop while the player cashes out and buys back in. Players wishing to wager more have to maneuver considerably more stacks of chips across the table. Payouts have to be made with multiples of the size of the stacks, and there are ample instances of table slowdowns because of the difficulty in the physical transportation and counting of chips at each stop of the ball.

The advent of increasing amounts of table electronics has also made the use of standard chips more difficult, and attempts to add electronics directly to the chips has been prohibitively expensive.

U.S. Pat. No. 6,753,830 (Gelbman) discloses a flexible electronic label that is capable of smart and dumb implementations as a stand-alone, remotely updateable, remotely alterable, flexible electronic label. The electronic label provides for displaying information in connection with an item or location. The label includes a display assembly having electronic ink disposed on a support, one or more antennas for sending or receiving signals corresponding to one of instructions, programs, data or selected indicia to be displayed by said display assembly, a storage element in circuit with the antenna for storing the instructions, programs, data and indicia, and one or more processors for intelligently determining the indicia to be displayed by the display assembly, for controlling and coordinating operation of the label, and for generating output signals for instructing the display assembly to display the indicia. The label is also identified for use in gaming environments and in the games of roulette and blackjack. The label is used in conjunction with an activator module that can be mounted or fixed at a selected location relative to the electronic label to promote communication therebetween. The activator can transmit via a transmitter a selected radio wave signal for powering the label and/or instructing the label to display particular indicia. When the integrated, remotely alterable and updateable electronic label is brought within the field or range of the activator output signal, the power antenna of the label can be activated by any power signals transmitted by the module. The power antenna receives the power signals generated by the activator module 18, which are then converted by the power converter into suitable power (e.g., current or voltage).

U.S. Pat. No. 6,733,388 (Mothwurf) describes a method for determining the total amount bet by individual players participating in multiple spins of a roulette game at a gaming table. The system includes a chipper machine and an intelligent table terminal. The method involves interfacing a chipper sorting machine with the table terminal, allocating a chip to a patron at the terminal, counting the number of color chips sorted by the chipper machine per color, and associating the number of color chips sorted by the machine per color with the patron. The total amount bet by that patron is then determined by mathematically linking the chip value of the color chip of the patron with the number of chips of the individual color sorted by the chipper machine in the time period in which the color chip is associated with that patron. A player's win/loss may be determined in part by pay chip movement detected by the chip tray, which is equipped with a system for detecting the instantaneous value of the chips on the chip tray, and thus also the change in value of the chip tray for any pay in or pay out, the table terminal prompts a screen asking to croupier to enter the playing position to which the pay chip movement belongs. The monitoring of movements of pay chips into and out of the chip tray together with the capture of all buy-ins (drops) and the repayment of markers thus allows the capture of the win/loss per patron. The win loss is the patron's net buy in (drop minus repayment of markers) plus the balance of the pay chips spent and received.

U.S. Pat. No. 6,506,155 (Mothwurf) describes a method for estimating the performance of a croupier at a roulette table. For each period of time the croupier is working at a roulette table the total amount bet by individual players participating in multiple spins of a roulette game is determined. The game that has a chipper machine and an intelligent table terminal. The method involves interfacing the chipper sorting machine with the table terminal, allocating a chip color to a patron at the terminal, counting the number of color chips sorted by the chipper machine per color, and associating the number of color chips sorted by the machine per color with the patron. The total amount bet by that patron is then determined by mathematically linking the chip value of the color chip of the patron with the number of chips of the individual color sorted by the chipper machine in the time period in which the color chip is associated with that patron.

U.S. Pat. No. 6,283,856 (Mothwurf) describes a method for determining the total amount bet by individual players participating in multiple spins of a roulette game at a gaming table that has a chipper machine and an intelligent table terminal. The method involves interfacing the chipper sorting machine with the table terminal, allocating a chip color to a patron at the terminal, counting the number of color chips sorted by the chipper machine per color, and associating the number of color chips sorted by the machine per color with the patron. The total amount bet by that patron is then determined by mathematically linking the chip value of the color chip of the patron with the number of chips of the individual color sorted by the chipper machine in the time period in which the color chip is associated with that patron.

U.S. Pat. No. 5,755,618 describes a roulette chip system providing an electronic output of the total value of chips stored in the chip tray and to automatically register any changes in the value of the chip tray.

U.S. Pat. No. 5,957,776 describes a gaming environment monitoring system that includes a chip inventory detector having a chip tray with a plurality of chips sitting therein. The chip inventory detector has a plurality of ultrasonic transducers mounted in an end thereof. One ultrasonic transducer is mounted in each cylinder or bin of chip tray. The ultrasonic transducer transmits an ultrasound pulse. The ultrasound pulse is reflected off of the last chip in the chip tray back towards transducer. Based on the time required for the reflected pulse to reach the transducer, the number of chips in that cylinder can be determined. The transducer is controlled by a plurality of conductors that are coupled to the remainder of the table control unit. Other sensors could also be used, such as optical detectors.

U.S. Pat. No. 5,770,533 (Franchi) describes a casino operating system for controlling the flow of funds and monitoring gambling activities in a casino or a gaming establishment utilizing a network of computers, including a central computer and individual game computers. Each player receives an encoded betting card from the cashier. At the games, each player position is equipped with a control panel including a card reader into which the betting card is inserted. The control panel also includes an electronic screen and keyboard. From the control panel, the player may place a bet and perform all options available to the player in the particular game. The system records the hands dealt to each player and the winner, and credits or debits the player's betting card accordingly. In an alternative embodiment, the casino operating system allows the players to use chips to place bets instead of the above-described betting card. The chips are marked or encoded so that they can be counted once final bets have been placed to determine the amount of each player's bet. In games requiring the placement of bets in certain positions on the gaming table, each player may be provided with a betting marker used to indicate the position of his bets on the table. A touch-sensitive screen maybe used whereby bets are placed by touching the desired position on the screen, or a two-way remote control console may be provided for entering bets.

U.S. Pat. No. 6,572,474 (Rudd) describes a croupier's payout calculation aid for calculating payouts for a game playable by a number of players, the game allowing a player to make multiple bets with chips of a distinguishable color that are used only by that player, at least some of the multiple bets having different payout odds as to a result determined by a spin of a rotating element. The aid includes: a data-input module including identifier data entry means having a data entry button dedicated to each respective color for entering data indicating the distinguishable color of chip corresponding to each of the number of players. The aid also includes a chip value data entry means for entering data indicating a corresponding monetary value for each the distinguishable color of chip. For each winning bet having different payout odds, bet entry means is provided for inputting data corresponding to the payout odds of a player's winning bet on a particular spin of the rotating element. A numeric value entry means is provided for entering a number of chips of the distinguishable color that were wagered by the player on each of the winning bets. A computation module coupled to the data-input module and arranged to compute payout data for the player is also included for that spin of the rotating element on the basis of entered data indicating a) the distinguishable color of chip, b) the corresponding monetary value for each the distinguishable color of chip, and c) each winning bet having different payment odds in turn, d) along with the sum of products of data corresponding to the winning-bet payment odds, and e) number of chips of the distinguishable color that were wagered. A display is coupled to the computation module to receive the payment data and display the number of chips of the distinguishable color won by the player on the spin of the rotating device. The cumulative total of the monetary value of the chips of the distinguishable color is displayed as data is input to the data-input module.

U.S. Pat. No. 6,567,159 (Corech) describes a system for recognizing gaming chips that includes pairs of light emitting devices P₁ through Pₙ, each pair of emitting light devices sensing a different color. The light is reflected off of the surface of the gaming chip, is sensed by a light detector, digitized by an analog to digital converter, and compared with stored intensity profiles for various denomination gaming chips. When a match is obtained, the system issues a signal indicating the color, and thus denomination, of the gaming chip. An energizing circuit produces a constant current to ensure a constant light intensity level. An automatic adjustment circuit changes the constant current to accommodate for factors such as component aging. The adjustment circuit is controlled by a calibration feature wherein light is reflected off of a calibration surface while the system is in use.

U.S. Pat. No. 6,075,217 (Kiritchenko) describes a chip sorting apparatus. The apparatus includes a chip transport mechanism, a light source positioned to direct light across surfaces of transported chips, and a detector positioned to detect light reflected from such surfaces and emit signals each indicative of a spectrum of light reflected by one such chip as such chips are transported. A signal analyzer compares detector signals with stored data representative of the colors of chips of a set of chips being sorted. The analyzer emits chip identifying signals reflective of such comparison. The apparatus also includes a sorter that is responsive to such identifying signals and directs identified articles from the transport mechanism into appropriate ones of a set of collection stations. A method of sorting a set of articles according to color is also disclosed.

U.S. Pat. No. 3,766,452 (Burpee et al.) discloses one example of a gaming chip that is adapted to be detectable by an EAS system so as to deter stealing of gaming chips by employees. The chips have a dielectric body with an inductive wire loop imbedded in the periphery of the chip and which terminates in a capacitive metallic bar. The inductive loop and capacitive bar cooperate with each other to provide a resonant electrical circuit. This resonant circuit responds to incident electromagnetic radiation at a preselected relatively high frequency to produce and radiate a unique detectable signal indicative of the presence of the chip in the incident field.

U.S. Pat. No. 5,406,264 (Plonsky et al.) describes an EAS detectible gaming chip having a disc-like body in which is disposed an amorphous magnetic marker material to simplify the structure shown in Burpee et al.

U.S. Pat. No. 4,157,139 (Bjork) describes a device for sorting discs or disc-like members of different identities (e.g. roulette chips). The device withdraws the discs from a receptacle by a conveyor and moves them in oriented succession along a sorting track where they are automatically identified and transferred by transfer devices into respective receiving spaces along the sorting track. The receiving spaces receive the discs at their lower ends so as to form stacks in the receiving spaces, the stacks being built up from their lower ends in inclined troughs forming part of the receiving spaces. Preferably each disc has its leading portion deflected upwardly as it approaches its assigned receiving space, while still retaining driving engagement with the conveyor, and the raised leading portion passes onto a disc catching member at the bottom of the receiving space, after which the disc is driven into the receiving space by the remaining engagement with the conveyor. The troughs of the receiving spaces are formed with longitudinal grooves carrying longitudinally displaceable devices engageable with predetermined numbers of discs at the upper end of the stack, such that the devices may be used to separate and remove predetermined numbers of chips from the stacks.

U.S. Pat. No. 6,685,584 (Oliver) describes a method of promoting play of a live casino card game for a group of players, the live casino card game having a computer system reading the monetary values from transponders in casino chips when placed as wagers on a table for the live card game, the method comprising: providing special casino chips to the group, each of the special casino chips having a promotion for the group encoded into its transponder, reading the promotion from the transponder of the special chip in the computer system when the special casino chip is placed by a player of the group on the table during play of the live casino card game, and enabling in the computer system the player to participate in the promotion in response to the reading.

U.S. Pat. No. 6,629,591 (Griswold et al.) describes a token for use in a cashless transaction involving an electronic device comprising a token body with a coin shape. The token has a digital circuit embedded within the token body and a memory embedded within the token body that is coupled to the digital circuit. The token also includes an input/output interface embedded within the token body that is coupled to the digital circuit and which enables the digital circuit to communicate with the electronic device. A computer program is adapted to interrogate the coin-shaped token for information stored in the memory by transmitting electromagnetic signals to an antenna embedded within the token.

U.S. Pat. No. 6,581,747 (Charlier et al.) describes a chip and method of manufacturing the chip. The chip includes a flat body made of a plastic material. The flat body has at least two parallel faces and a cavity which opens to at least one of the at least two parallel faces. The cavity is adapted to receive an electronic identification device. At least one plug made of a plastic material is included. The at least one plug is adapted to be inserted into the cavity. The electronic identification is retained in the flat body when the at least one plug is inserted into the cavity. The method includes making the flat body, forming a cavity in the flat body, placing the electronic identification device in the cavity, inserting the at least one plug in the cavity, and fixing the at least one plug to the flat body.

U.S. Pat. No. 6,264,109 (Chapet et al.) describes a chip or token including a plastic cover having an external surface and a base engaging surface. A plastic base has an external surface and a cover engaging surface, the base being attached to the cover. An axial spacing projection maintains a space between the base and the cover, the axial spacing projection being disposed on the cover engaging surface of the base and including a first height. The axial spacing projection further includes one of a continuous ring and a discontinuous ring. A closure ring disposed on the base engaging surface of the cover comprises one of a continuous ring and a discontinuous ring. A peripheral annular region includes a space having a second height and is disposed adjacent an edge of the token, the peripheral annular region being defined by the axial spacing projection. The first height is approximately equal to the second height. An electronic device includes an electronic circuit that includes one of a memory containing identification, coding information, and a transmitter-receiver having a peripheral antenna. An internal central region includes a receptacle for receiving the electronic device, the internal central region being defined by the axial spacing projection. A plastic jointing material is disposed in the peripheral annular region, wherein the plastic jointing secures the base to the cover. The closure ring includes an engaging diameter that is smaller than a diameter of the axial spacing projection such that the closure ring and the axial spacing projection engage and axially overlap one another when the cover is fixed to the base.

U.S. Pat. No. 6,021,949 (Boiron) describes a gaming or casino token or chip having a thick flat plastic body provided with a circular through hole in which an electronic identification element is placed. The casing of the device is protected by two protective wafers. The permanent integration of the casing in the body is supplemented by attaching, for example by laminating, a plastic covering sheet in each face of the body. This forms a monoblock rigid assembly for the electronic identification device. The device includes a memory that stores identification codes and an inductively coupled transmitter-receiver equipped with an antenna.

U.S. Pat. No. 5,735,742 (French) describes a system for tracking movement of gaming chips within a casino, wherein the gaming chips carry electronically ascertainable information about the gaming chips. The casino comprises a vault for receiving and storing gaming chips, a cashiers cage for disbursing and cashing out gaming chips, and a plurality of gaming tables. The system comprises at least one antenna associated with the vault for scanning gaming chips entering and leaving the vault, at least one antenna associated with the cashiers cage for scanning gaming chips entering and leaving the cashiers cage, and at least one antenna associated with the gaming tables, for scanning gaming chips at the tables. It is preferred that the scanning step in the vault include the step of encoding the memory in the chip with a voidable casino security code, so that the chip may be easily invalidated automatically if desired, and that it further includes the step of recording movement of the chip between locations, so that a transactional history of the chip is preserved in memory within the chip.

U.S. Pat. Nos. 5,651,548 and 5,735,742 (French) describe a method of tracking movement of gaming chips in a casino. The method uses gaming chips each having an electronic circuit that transmits information, and antennas located at gaming chip placement areas. When gaming chips are placed on a first gaming chip placement area within the casino, the antenna at that first gaming chip placement area transmits a radio signal which in effect scans the electronic circuits of the gaming chips. The electronic circuits identify the gaming chips by electronically broadcasting information. Upon moving a first of the gaming chips to a second gaming chip placement area, the antenna at the second gaming chip location transmits a second radio signal which scans the electronic circuit of the first gaming chip. The electronic circuit in the first gaming chip identifies the first gaming chip on the second gaming chip placement area so that the location of the first gaming chip is tracked. The gaming chip placement areas may be physically located at various places such as on a gaming table or a gaming chip tray.

U.S. Pat. Nos. 6,464,584 and 6,186,895 (Oliver) describes an intelligent casino chip system. At least one gaming table is provided with at least one discrete player area. Two classes of intermingled gaming chips are accepted in the discrete betting area. Each gaming chip of the first class has a first transponder containing at least value information. Each gaming chip of the second class has a second transponder containing value and class information. The computer system determines the values from each class of chip and the class information from the second transponder.

U.S. Pat. Nos. 6,296,190 and 5,166,502 (Rendleman) describe a gaming chip that includes a base ring that defines a central aperture, within which a unitary cup is disposed. The cup has first and second recessed cavities therein. A transponder is disposed in one of the first and second cavities and an antenna is disposed in the other of the first and second cavities. The antenna is electrically coupled to the transponder and a cover is secured over the cup to maintain the transponder and the antenna within their respective cavities. A method for making a gaming chip is also provided.

U.S. Pat. No. 5,895,321 (Gassies) describes a gambling chip having the general shape of a disc, the chip housing two identical half-discs in contact via axial spacing rings respectively located on their internal faces. The half-discs are made of rigid plastic and are fastened together by injection of a plastic seal on the edge of the chip into a peripheral annular region lying between the two half-discs. The half-discs have a central recess forming an internal central region housing an electronic identification device embedded in a wafer based on epoxy resin.

The table game of roulette is well understood by most casino players, and a brief summary of the play of the game on a known automated system described in Mothwurf, U.S. Pat. No. 6,283,856 is provided here. Referring to FIG. 1, at the start of a game of roulette, a croupier 20 is present at the dealer position. Various players 22 have arranged themselves around the roulette table 10. It is usual for each player to play the game of roulette with a different color chip uniquely associated with that player, so that winning and losing bets can easily be identified.

It is typical for a minimum bet to be required for each wager placed at a roulette table. This is the minimum amount that can be bet on any wager at the table or is the minimum total amount that can be placed for any spin of the roulette wheel. There is also a minimum value that each chip may have at each roulette table. Different players may, of course, wish to play at different levels or stakes then other players. The roulette table must therefore make provision for higher values to be associated with the specific color chips of those players 22 wishing to play for higher stakes. To make sure that all players are aware of the value of each chip on the table, a sample chip of each color is normally hung on a rack (not shown), with the monetary value of the chip being associated with a graphical value indicator in the rack adjacent to the chip. In other casinos a transparent value marker called a lamel is placed on a color chip in a display area and the value represents a stack of 20 chips of that particular color. In order for the players to bet higher amounts of money, the player must either bet more chips or cash out and buy in at a higher chip value for that color of chip.

When the game first starts, it is necessary for each player 22 to acquire a supply of chips for use during the progress of the game. There are several ways that this can be done. First of all, it is possible for the player to pass money, ordinary casino chips of value, or a marker to the croupier, who then places the money in the drop slot 32 and passes the corresponding number of color chips to the player. For this purpose the croupier would normally take a number of stacks from those arrayed in front of him, in each case in the color associated with the respective player. It is a convention that each of the stacks 38 contains 20 chips each.

Once all the players have acquired a supply of chips, the game may start. During the play of the game, each player must play with only a singe denomination of chip. As is well known, the conventional roulette wheel 12 comprises an annular casing 40 containing a static, inwardly sloping rim 42, within which there is mounted a rotatable cylinder 44. This cylinder 44 has an outer ring of numbers 46 corresponding to the numbers of the bet placement area 18, and an inner ring of pockets 48, which, in the same way as the outer numbers ring, is arranged concentrically to the cylinder. Each of the individual pockets 48 is associated with one of the numbers on the numbers ring and is isolated from its neighboring pockets by vertically and radially disposed separators 50. Inside the ring of pockets 48, there is a central dome area 52.

In use, the cylinder 44 is spun in the one or other direction and then a ball is projected by the croupier to run around the rim inside the annular casing 40. The croupier will spin the ball in the opposite direction of rotation of the cylinder 44. The ball will gradually slow down. The centrifugal force keeps the ball within the rim 42 of the wheel 12 and will reduce the magnitude, so that the ball gradually falls down the rim and passes over the numbers ring 46, where it may bounce off one or more of the separators 50 or off the dome before eventually landing in one of the pockets 48, which is the winning pocket, i.e., the winning number.

The players 22 are able to place their bets on the bet placement area 18 until the ball spinning in the rim 42 has slowed down so that it leaves the rim 42. For those not familiar with the game of roulette, it should be noted that it is usual for a player to use several chips, and indeed to make several different bets for each spin of the roulette wheel. If a single chip is placed on a single number, then the chance of that number becoming a winning number is 1:38 (when there are both a “0” and “00” present on the wheel. The chance becomes 1:37 when there is only a single “0” on the table.) These odds follow from the fact that in American roulette, there are a total of 38 numbers on the number ring, namely the numbers zero and double zero (both green) and the numbers 1 to 36, and 38 pockets associated with them (one pocket for each number) and there are 37 numbers on a European wheel, with numbers 1 to 36 and the green “0” as the last possible event.

If a player places a single chip on a single number and loses, then the chip is scooped by the croupier into a chute 54 associated with the chipper machine. If, however, the number selected by the player comes up, then he is given 35 chips by the croupier in addition to recovering the one chip stake he originally played.

If the player places 4 chips on the single number and the number wins, then he will be given 4 times 35, or 140 chips by the croupier.

Another betting option is for the player to place a chip so that it straddles two numbers. In this case the chance of winning is 1:18 (2 numbers out of 36 chances on a 0-00 wheel). If the player wins, on either of these numbers, he is given 17 chips by the croupier for each chip placed by him.

It is also possible for a player to place a chip so that it lies across four numbers. In this case his chance of winning is increased, but the returns if he does win are also reduced, and for each chip placed in such a way he will receive eight further chips from the croupier and will also have his stake returned to him.

It is also possible for a player to place a bet on five numbers, for example on the numbers 0, 00, 1, 2 and 3. In this case his chances of winning are again increased. However, if he does win, the number of chips he receives from the croupier is reduced to six for each chip he has bet in this way.

Another possibility is for the player to place a chip on three numbers. In this case he receives 11 chips from the croupier for each chip bet. A further possibility is for him to place a bet on six numbers. In this case he receives five chips from the croupier for every one he has bet.

Yet another possibility is for the player to bet on columns of twelve numbers. In this case the chance of him winning is much higher, but if he does win, his win is reduced to two chips for each chip bet in this way.

It is also possible for a bet to be placed on twelve numbers chosen other than in columns, for example on the top three by four array of the numbers 1 to 12, on the middle three by four array of the numbers 13 to 24, or on the bottom three by four array of the numbers 25 to 36. Again, the chance of winning is high, but the returns for a win are lower; and the croupier will only pay the player two chips for every one bet.

Another form of bet is possible referred to as a “chance simple”, and involves a bet placed on any one of the number of so-called “chances”, referred to as “rouge”, “noir”, “pair”, “impair”, “manque”, and “passé.” For example “rouge” signifies that the player bets simply on the color red. In this case the chance of winning is high (18/38 with a 0-00 wheel), but if the player wins, he only receives one chip from the croupier, in addition to the chip he originally bet. If he lands on a zero or double zero the bet is held by the dealer until the next spin. If the player's color comes up, the bet is returned to the player.

Every bet that is not a winning bet is collected by the croupier, the color chips are placed in the entrance to the chute leading to the chipper machine 14. The chips are then sorted by the chipper machine according to their color and are arranged in stacks within the chipper machine, from which the croupier can take stacks of twenty chips each to replace those on the table that he has used up. At this stage it should be noted that when paying a player for a winning bet, the croupier will take a whole number of stacks present on the table, will break one of the stacks and will put the chips not owed to the player back into the chute of the chipper machine.

For example, if the player has bet two chips on a single number and won, then the croupier must pay him 70 chips of the same color. To do this, he will take four stacks of 20 chips each, totaling 80 chips, will pass three full stacks to the player and will break the fourth stack so that the player receives 10 chips. The remaining ten chips are placed in the chute associated with the chipper machine.

There may be some unique procedures in the use of known apparatus that can be practiced in the present technology, even in the use of the chip sorter. As indicated above, the chip sorter may be used at different stages of the same round of spinning the wheel. For example, the chip sorter (also known as a “chipper”) is traditionally used as a counter for only chips swept from the table as losing chips. This provides a running count of only how much is being lost to the house, and this is not an accurate estimate of how much is being wagered, much less a count as to what the true revenue stream may be (including wagers, losses, and winnings appropriately accounted for). If the following sequence is used, a much more accurate and true reading and accounting of events at the roulette table can be provided. The use of the chip sorter in this process is itself a novel process with novel event sequencing and programming provided. Prior art methods have attempted to estimate wagers on winning bets, but prior to the present inventory method, no accurate method of measuring wagers made existed.

### SUMMARY OF THE INVENTION

The technology practiced according to the present disclosure is referred to herein as the “Roulette Revenue” system. The Roulette Revenue system may be generally described as a physical and processor based system for receiving data regarding casino wagering chips that have been electronically assigned a temporary value. The Roulette Revenue system is dependent upon a specific format of chip valuation technology generically referred to herein as the Electronic Value Marker Tree (the EVMT) that electronically assigns a temporary value to colored chips. One narrow embodiment of the EVMT is as a vertically disposed device having two opposed inserts as the ‘branches’ on the tree. One insert (see attached FIG. 2), showing ten positions for pairing chip colors and/or chip sorting channels electronically with a temporary value. One side of the device is suitable for inserting standard multiple colored wagering chips, and the other opposed insert has the “marker” (electronic chip or board) inserted. As each player arrives at a table, a specific color chip (having no initial value) is assigned to that player by placing a marker chip in the insert adjacent to the player's selected chip color. The player typically chooses a color of chip. A marker is inserted into a slot adjacent to a slot designated for that color chip in one example of the invention, and this marker provides information (through electronic communication or infrared detection, for example) that is sent from the Tree to a processor (e.g., lap top, game controller, central processing station) to assure that a specific temporary value is assigned to a specific chip color. In a preferred form of the invention, each position 1-10 is preassigned a chip color and there is a designated channel in the chip sorting machine that is associated with each position. Flow of chips in the game can be assessed in the Roulette Revenue system based on the actual values assigned to each chip color, and the activities of individual players that are tracked. In one form of the invention, all lost wagers plus an equivalent amount of chips of a color corresponding to a winning players wager or wagers are fed back into the chip sorting machine. Measured values represent total amounts wagered per channel, per color, per time increment, etc. Another proprietary component, the Easy Chipper® reads the value of the chips using IR radiation to distinguish the color of the chips. The information on the numbered and colored chips is sent to an external processor where the information is evaluated according to the analytical or reporting software of the Roulette Revenue system.

Multicolored casino wagering chips are assigned temporary values (one value per color) and those values are transmitted to a separate device, such as an external computer or directly to a chip sorter processor and is used to determine chip values and value flow (wagers lost to the house) or total amounts wagered during a casino table game. A single color chip is temporarily associated with a chosen value for that color chip, and the value/chip relationship is provided to all systems that use that relationship in assessing game performance, wins, losses, payouts, record keeping, and security for the table game. In one embodiment of the technology described herein, a set of opposed slots on a rack is provided, with a single color of chip and an electronic marker positioned on an opposed pair of slots. The marker sends out a signal regarding the temporary value of the color chip, and that sent value is used by all automated systems on or about the gaming table to assign value to that color chip. The position of the chip in one embodiment corresponds to an assigned channel in the chip sorter and the color of chip assigned to that channel. In other embodiments, the chip color is inserted into any chip-receiving area 26 and a color reader reads the color and transmits a signal representing the color to the processor. At the conclusion of play with a particular color of chip, all the chips are returned by the player, the chips repurchased, and the value is discontinued for that particular chip. The markers and chips may be displayed on the rack for visual inspection during play. The markers bear markings that represent the temporary value of the color of the adjacent chip in the tree.

### BRIEF DESCRIPTION OF THE FIGURES

FIG. 1 shows a prior art Roulette layout utilizing an automated player tracking and chip tracking system.

FIG. 2 shows an exemplary Electronic Value Marker Tree (EVMT).

FIGS. 3 and 4 are flow diagrams for practicing certain methodologies of the chip valuation and Roulette Revenue system in combination with the EVMT chip valuation technology.

### DETAILED DESCRIPTION OF THE INVENTION

The amount of wagering performed by an individual player at a roulette table can be difficult to determine with any accuracy, as the wagering can be and usually is done with an individual player's chips positioned in many different areas of the betting table, in different sizes of stacks, and in competition for space with different color chips and different size stacks of chips of other players. This complexity of chip distribution on the betting surface makes estimation of chip wagering on a roulette table very difficult. Sophisticated devices (e.g., multiple cameras at different angles, combined with chip tray analysis and the like) would be very difficult to implement and are likely to be too costly to provide the technical sophistication needed for an accurate system. Relying on default values, or estimated values for chips when counted or manually inserted (by the dealer) chip values leaves the system open for significant valuation errors or manipulation of values by the dealer, either accidentally or intentionally.

In combination with the electronic chip valuation systems described herein, a wagering analysis system such as the following may be practiced. Determination of the total amount bet in a plurality of spins of a roulette game in a given period of time can be accomplished by using a gaming table fitted with a chipper machine (chip counting and chip sorting) an intelligent processor (located at the table or in communication with the table) and an electronic value marker tree for temporarily associating a chip color with a value. The method comprises: providing a chip sorting machine to interface with a processor; electronically assigning a uniform value to all chips of a specific color; transmitting the assigned uniform value to the processor and/or to the chip sorting device; the chip sorting machine taking a count of the number of each color chip sorted by the chipper machine and associating the number of the count with the color of chip; where a record is maintained of the wagering and/or lost wager history by table, by unit of time, by chip color or by any other useful data collection technique. The method may include the step of first collecting losing wagers and sorting the losing wagers in the chip sorting machine, the paying winning wagers on the table and then depositing a number of chips of a color corresponding to winning bets placed into the chip sorter. The chip sorter then is able to measure all wagers placed to accurately determine (gross) revenue flow. By combining this system with a player identification/tracking system, the total amount bet by that patron can also be determined.

According to the present invention, the players may receive chips in the ordinary fashion or preferably use the EVMT system to have the chips provided with a temporarily assigned value. After the dealer inserts a marker of the desired denomination and a corresponding chip color into the marker tree, the wagers are placed in the conventional manner. The wheel and ball is spun, and the ball then stops to identify the winning number/color. The croupier sweeps the losing wagers from the table and drops them into the chip sorter. The chip sorter sorts the chips according to color, counts the chips according to color, and then collects them separately. While the chips are being sorted, payouts are made on winning wagers and the winning wagers and payouts are made to the players. According to one preferred method, before the chip sorter has completed its operation, the croupier removes a number of chips of a color played by the winning player or players, and adds a number of chips equal to the amounts wagered by the winning players to the hopper. The chip sorting machine therefore captures total amounts wagered, rather than just wagers lost to the house.

The information (comprising at least the number of chips and the color of each number of chips) is forwarded to a processor. This first sorting, or series of sortings of numerous collections of chips must be sent to the chip sorter, identifies the total wagers made for a round. After the wagers have been collected and sorted, a change of mode may be optionally effected in the sorter. After the completion of the first mode, there may be an input to the sorter (e.g., switch, processor command, panel entry, buttons, touch screen, voice activated command, etc.) to switch modes from counting wagers placed (and transmitting data on) to counting lost wagers. The dealer would then sweep only lost wagers into the chipper. Other modes may include counting winning wagers (according to the nature of the wager), counting wagers plus winnings (provided by normal methods to the table by the croupier), etc. The croupier's chip handling rules would necessarily vary with the selected mode. If the mode switch on the chipper is to a mode of (manually) counting winning wagers placed, there should be a basis for inputting the nature of the wager as chips are placed into the sorter. This can be done by a touch screen panel or other data entry device by a sequence of a list of wagers and then the croupier adds those wagers in sequence. It does not matter if a player has made many different formats of wagers, as the chip sorter sorts according to color (and now wagers) and totals the winnings for the round. For example, there may be a sequence of wagers programmed into the sorter and displayed on the sorter or a display screen in communication with the sorter. These would include, for example, “Single Number,” “Two Numbers,” “Three Numbers,” “Four Numbers,” “Five Numbers,” “Six Numbers,” “Color,” etc. according to the available bets. After each type of wager has been exhausted on the table, the mode switch may be changed back to count total wagers in the next spin of the roulette wheel. The chip sorter would send the information to the processor that included not only color of chips, number of each color of chips, and the odds to be paid (based upon the nature of the wager) for each specific count of chips. If the system of the present invention were combined with a player tracking system, the system would then be able to display the specific number of each color chip to be returned to each player after each spin. This would also provide a complete count of chip movement for each round including wagers, losses, amount wagered by each player, and winnings on each player.

An alternative mode would be for the croupier to place the winning amounts next to the wagers (as in standard play), then run the winnings and the initial wagers through the chip sorter, collect the sorted chips and distribute the winning wagers and payouts to the appropriate players. This method would also provide an accurate accounting of all wagers, winnings and losses that occur on each round of play and over the course of play for each player.

Chips or tokens of sufficient color variation to be visibly observed and mechanically read (e.g., optically) are provided. These chips do not have to have any value indication on them, and preferably do not have any value indicia on them. These chips are associated with a color reading system that reads the colors of chips within the chipper machine, and these colors are then temporarily assigned a selected (e.g., player selected or casino selected) value. Each color may be pre-assigned to a channel in the chipping machine. The assigned values and corresponding colors may be transferred to a processing system that will be used to assess game play, game performance, value transactions, wins, losses, or any other event where the value of one or more chips is to be used. That event involves reading the color of the chip, determining the number of chips of that color, and providing a total value for the chip(s) based on that number and value. The simplest example of such an event is after play of a round of a casino table game, chips are collected, assorted, counted, and the results of that round of play are determined automatically. Another example of use would be where a dealer indicates a specific value of winning for a player (having a specific color of chip), commands a chip delivery system to provide a specific payout to that player, and the delivery system counts out the specific number of chips of that color (and assigned value), and delivers that number of chips of that color to the dealer for delivery to the player.

A system referred to as an Electronic Value Marker Tree (hereinafter EVMT) is provided that temporarily associates a specific valuation to a wagering token, set type, such as color and in one embodiment the associated value can be added or changed without any need to manually enter new value data into the system via a keyboard. The associated value is provided from an electronic assembly that associates a color or channel assigned to a color with a specific value and provides that tied value/color information to other electromechanical or optomechanical, or electro-optical equipment that can use that value/color information in part of the equipments function. A more complete description of such a device can be found in co-pending patent application Ser. No. ______ filed Sep. 23, 2004, entitled: Electronic Value Marking for Wagering Chips. The content of this application is herein incorporated by reference.

The presently described technology performs by a first device associating a specific color and/or channel assigned to a color with a specific value for the chip, and then providing that information to other devices that can use that information. The information may be updated at any time by the first device, and the other devices might be able to, can or must query the first device to use the most current information. The structure can vary in complexity and provide varying levels of security against tampering as the system changes. Among the various design, performance and structural formats are contemplated:

1) A system can be provided where chips are placed into a receiver that is an information effective physical distance from the EVMT. The EVMT may read information from the chip (the information may be as simple as the color of the chip) or may have a series of chip insertion ports that have been pre-assigned a chip color corresponding to a channel in the chip sorter. The EVMT also reads value information from a value chip of a selected value inserted in a slot adjacent to a selected color chip. Information can be entered via a separate player tracking system identifying a specific player for that color. The chip may thereafter be displayed in association with a value on the EVMT or elsewhere (e.g., on a separate rack). The information at least relating to chip color and chip value (and possibly also player position) is then transmitted to associated other devices (e.g., such as an external computer or a chip sorter) that can use that information. A simple design would include slot racks for multiple color chips that have a color reader that reads chips when they are inserted into the slot rack, and different slots in the racks have specific values associated with them. For example, a top slot could have a $100 value, a second slot $50, a third $25, a fourth $10, a fifth $5, and a last slot have a value of $1. Each chip inserted into that single slot would be displayed and would have the associated value. The dealer could reprogram the value for each slot and add new or different visual indicators (if desired) to display the value of the chips by simply unplugging the value chip of a first denomination and replacing it with another value chip of a second denomination.

2) A system can be provided that provides multiple pairs of opposed slots or tracks for inserting opposed pairs of a) chips (of a predominantly single color or a predominantly single color other than a background color or colors, such as black and/or white and/or gray as the background) and b) electronic boards or chip boards that identify specific values that are to be provided to other devices. By inserting a chip of a predominant color and the chip board or “marker” of a specific value into opposed slots or tracks, combined color/value information can be provided from the valuation device (the EVMT) according to the techniques taught herein.

A review of the Figures can assist in a better understanding and appreciation of the technology described herein.

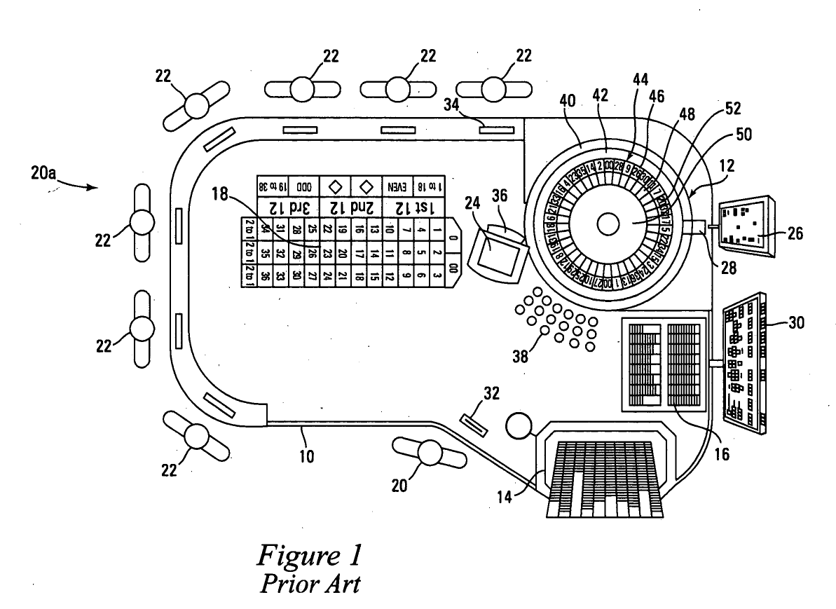

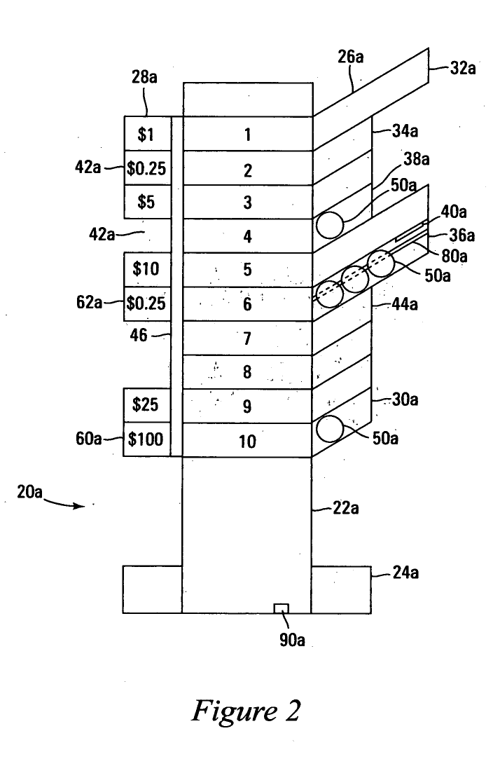

FIG. 1 shows a schematic rendition of a frontal view of an EVMT system 20a according to one embodiment of this technology. The EVMT tree 20a comprises a vertical trunk or support 22a and a supporting base 24a. There are adjacent opposed chip accepting tracks 26a and marker accepting tracks 28a on the vertical support 22a. Individual wagering chips 50a are shown in some of the chip accepting tracks 26a. For example, wagering chip accepting track 30a shows a single wagering chip 50a as part of an opposed pair of a wagering chip and electronic marker 60a (a $100 marker) in pair 10a on the EVMT system 20a. The color of the individual wagering chip 50a in track 30a in the simplest form of the invention is pre-assigned to a chip acceptor track 26a. The same track is associated with a particular channel in the chipper machine so that all chips of a certain color are always sorted in the same channel, regardless of value. In another embodiment, each inserted chip is read (as with an infrared scanner or color reader (see 40a in wagering chip track 36a), or by electronics in electronic marker 60a that has an optical or other communication channel to the individual chip 50a in wagering chip track 30a. In the latter case, the electronic marker 60a alone, or in cooperation with an infrared color identification system (not shown) built into the vertical support 22a or into the opposed wagering chip track 30a (again see 40a in track 36a) will cooperate to provide information on color/value association that will be output (e.g., through data port 90a) to other devices such as an external computer. The wagering chip accepting tracks 26a are shown by way of example as having different lengths, as in tracks 32a and 34a. The tracks may be of uniform length on a single EVMT 20a or as shown in FIG. 2, have different lengths. One track 30a is shown of a length that will accommodate a single chip 50a. Another track 36a is shown as able to accommodate at least three individual wagering chips 50a. In a track that accommodates multiple chips, a mechanism must be provided that can identify the colors of the wagering chips in that individual track and provide that information so that it can be associated with a value and sent as a signal relating to color and value. This can be done in a number of ways. As non-limiting examples of the ways in which this color data can be provided are assigning a chip color a permanent location in accepting track 26a by providing a color sensor in the marker (e.g., 62a) or in the vertical support 22a position 10a that can sense color in all chips present in track 36a, a color sensing strip 80a inside of the track 36a that can sense multiple colors on multiple chips 50a in the track 36a, or a color sensor 40a that reads the color of individual chips as they are inserted into the track 36a when the individual chips 50a pass the sensor 40a. A larger track 36a accommodating multiple chips might well be used with denominations of chip value that are more common, such as $0.25 or $1.00 value chips. The use of tracks that accept multiple wagering chips could provide either more economy of space vertically (y necessitating fewer tracks) or allow for more than 10 players at a table when there are only 10 tracks. The individual electronic markers (e.g., 60a and 62a) are chip boards or other electronic elements that contain at least value information that can be transmitted to other devices, for example through port 90a or by preferred wireless transmission to other devices with wireless receivers. The individual electronic markers (e.g., 60a and 62a) may be permanently attached to the EVMT system 20a (which is less preferred) or may be readily removable and replaceable by the dealer or the casino. The system would easily permit a player to select another denomination to play. At the end of a sort, the croupier would simply replace the electronic marker with a new one of a second denomination. In a structure where all wagering chip accepting tracks 26a are of equal size and accept only single wagering chips, there must be multiple markers available for a common value to be assigned to the wagering chips. That is, there may be a need for 10 markers for a value of $1.00, 10 markers for a value of $0.25, etc., so that if ten players wish to wager with the same value of chip, they can be accommodated. Wagering Chip track 34a is shown with no chips therein and a marker having a value content of $0.25 in the opposed marker track 42a. The absence of a chip may authorize the EVMT system to either indicate that no signal is to be sent from any reporting function associated with tracks 34a and 42a, or send a signal that there are no chips in track 34a even though a value of $0.25 is associated therewith. Track 38a is shown with a single chip 50a therein, but space 42a in the series of electronic marker tracks 28a does not have a marker therein. The absence of a marker may authorize the EVMT system to either indicate that no value has been assigned to the individual chip 50a in wagering chip track 38a, indicate that the specific color of the individual chip in track 38a has not been assigned a value, or any other signal that is thought to be appropriate.

The EVMT system may be configured in any of a number of ways limited only by available technology. For example, the signal carrying the color and/or channel plus value information relating to individual colors of wagering chips sent by the EVMT system to other devices may be sent by a port connection 90a or by wireless connection by any electromagnetic transmission method. The transmitter for the information may be in the individual markers, in the individual marker tracks, or there may be a single EVMT transmitter that receives internal signals from the color sensors and the markers (which may be one and the same or different as described above) and then transmits the information to other devices by port or wireless connection.

The operation of the system may also be varied according to the individual wishes and business practices of the casinos using the system. At the beginning of play or the opening of a table, some or all chips will not be in the EVMT system and will not have any value associated with their specific color. When a player arrives, the player will select a color that will be that player's color chip, and will inform the pit crew or dealer of the value that is to be assigned to that player's chips. The dealer will then insert an electronic marker into the EVMT or use a track with an appropriate electronic value marker built into it, and an activation switch (either on/off or allowing/enabling data introduction or transmission) may be optionally provided. If a player tracking product is used in connection with this method, the specific color for that player will then be provided to the EVMT, either by direct data input (a less preferred method with data entry available on a panel on the EVMT) or by insertion of the color wagering chip into a wagering chip opposed track and by using a player-input device such as a card swipe. In yet another example of the invention, the colors are each preassigned to a channel and a position on the marker tree and only the electronic marker value needs to be inserted into a corresponding slot. The information (comprising a specific color of chip and a value associated therewith) is then able to be provided to other devices within the casino. The information may be immediately transmitted to one or more other devices (e.g., a chip reading tray, a table analyzer system with visual input, a chip sorter, a bet recognition system, a table game processor, a central game processor, and the like) or may be transmitted upon command (e.g., at the beginning or end of each spin by a roulette wheel, at a signal that a spin has been completed, upon dealer command, upon insertion of chips into a tray, upon insertion of chips into a sorter, upon collection of chips in individual containers after sorting, etc.). The command may be automatic or manually (dealer) input. The other devices use this information according to their individual functions. For example, a chip sorter will identify how many chips of each color have been collected after each roll of the ball and will either compute that value and send it to a computer (table, pit or casino central) for the computer to receive, store and or analyze, or the chip sorter will provide only the data regarding the number of chips of a specific color and the computer that has also received the color/value associated data will compute the value of that number of chips. The final data regarding the value of wagers placed (the sum of chips lost plus added winning wagers) can be stored in the computer for later use or used immediately for any casino directed purpose. For example, the computer can determine total value of wagers placed or lost per spin, total value of wagers placed or lost per player per spin, total value of wagers placed or lost per unit of time, total value of wagers placed or lost per session, total value of wagers placed or lost per unit of time, and provide any other analytical format from available information. This type of information can be very important to the casino in maximizing personnel usage and in monitoring player and dealer activity, as well as monitoring individual game activity. When a player wants to cash in chips and end the individual player's session, the chips may be counted by the chip sorter, a final tally of player's holdings in chip determined, that information provided to the table crew, and the player can be paid in standard casino chips, currency or with a refundable ticket or account credit. If the tally shows that all chips of a specific color have been returned to the table, the chips valuation for that color can then be deactivated. This deactivation can be done in a number of ways, such as removing that particular color chip from the EVMT which would (automatically or by dealer command) cause a signal to be sent to the other devices of a change in valuation for that color (to, in essence, make it valueless), removing the electronic marker from the opposed marker track EVMT which would (automatically or by dealer command) cause a signal to be sent to the other devices of a change in valuation for that color (to, in essence, make it valueless), or by manual activation of a function that would deactivate an opposed pair of tracks (which would be useful for single chip tracks) in the EVMT which would (automatically or by dealer command) cause a signal to be sent to the other devices of a change in valuation for that color (to, in essence, make it valueless). The deactivation of an opposed pair could be effected by a button or switch available to the dealer that would be used, and then the chip in that pair of opposed tracks removed and/or the electronic marker removed. At this point, only those wagering chips in play will still have retained values within the system parameters. The player may request that the dealer retain the value for chips that he has removed from the table to retain their value for a limited period of time, in expectation of the player's return to the table.

There are numerous aspects to the practice of the technology described herein, non-limiting examples of which include but are not limited to the use of a wagering chip value association marker comprising a chip board that can be positioned adjacent to a colored casino wagering chip, the chip board containing information related to an absolute economic value that will be assigned to a casino wagering chip, that value information being capable of being associated with specific color and/or chipper channel information. There may be circuitry capable of receiving data from a color sensor and being able to forward that data from the color sensor in a format associating a determined color with the absolute economic value, and the color sensor may even be part of the electronic marker. In other forms of the invention, no color sensing is necessary because the chips are inserted into designated slots assigned to that color. The marker may have transmission capability for the value information and optionally for the color information.

Also described herein is an electronic value marking tree comprising chip boards containing information related to a temporary absolute economic value that can be assigned to a wagering chip, a receptor for a wagering chip that informationally associates a wagering chip with a single chip board containing information related to the temporary economic value, an optional color identifier, and an informational communication component having external communication capability. The term absolute economic value means that there is a specific value, such as $1.00, 100 Yen, 10 Euros, 5 Rubles or the like, associated with the color as a true value. The chip boards that contain information related to an absolute value may also contain a color sensor embedded onto the same board. There would be a direct visual transmission capability between the light sensor and the wagering chip so that the color of a chip positionally located with respect to the sensor could be determined and the color information forwarded. The sensor could, for example, emit radiation (white light, infrared light, specific spectra or combinations of electromagnetic radiation, and have a sensor that can interpret returning electromagnetic radiation as reflected from a particular color. This can be easily done by training the equipment at each casino site, using the actual colors of wagering chips that each casino would use. As noted earlier, the chip boards containing information related to an absolute value may be manually removable from and insertable into marker receptors on the marker tree. They may slide, snap, or plug into place according to various connection designs available. The information communication component may be communicatively linked to the color identifier and to the chip boards containing information related to an absolute value, and the information communication component is capable of communicating information from the color identifier and the single chip board so that an absolute economic value is associated with an individual color of wagering chip. Communication from the combined component system can be wireless. The wagering chip acceptors can receive only a single wagering chip at a time or multiple wagering chips at one time. The marker tree may have its information communication component in ultimate information communication with a various other devices and processors around the casino, such as a game computer, a host computer or a chip sorter. One method that can be practiced is to temporarily assign a value to individually colored wagering chips by positioning the colored wagering chip adjacent to an electronic source of value information, sending value and position and/or color information from the source to a processor, and basing valuation of wagering chips that are counted in a finite period of time upon both the color information and value information assigned to that color. Pairs of slots may be provided, a colored wagering chip is inserted into a first slot of a pair of slots comprising a wagering chip acceptor, the electronic source comprises a chip board having electronic information and is inserted into a second slot of an opposed pair of slots and comprises a chip board receptor, and color information is obtained from the wagering chip acceptor and value information is obtained from the electronic source to form color-value information, and that color-value information is transmitted to a device external to the electronic source. Transmitted color-value information is sent to a data processor that has access to totals of chips according to color. The data processor calculates a value of wagering chips for a particular color based upon the color-value information and a total of chips of a color included in the color-value data.

The EVMT may basically described as a physical and information system for receiving casino wagering chips that contain an electronic chip and a visible marking function identifying the value of the chip and providing information to other devices related to the value of specific color wagering chips. A preferred EVMT is a relatively vertical device having two opposed inserts as the ‘branches’ on the tree. One insert (see FIG. 2 showing ten opposed inserts on opposite sides of the center support) has an individual color wagering chip in it, and the other opposed insert has the individual electronic “marker” (electronic chip board) inserted. As each player arrives at a table, a specific color chip (having no initial value) is typically selected by and then assigned to that player. A marker is provided in a slot opposed to a slot or track for a specific color of chip, and this marker provides information (e.g., through electronic or infrared detection) that is sent from the Tree to a processor (e.g., lap top, chip sorter, chip reading chip tray, game controller, central processing station etc.) to assure that a specific value is assigned to specific chip colors. Flow of chips in the game can be assessed based on the actual values assigned to each chip color, and the activities of individual players can be tracked.

The technology disclosed herein relates to a number of related aspects of roulette table value management and reporting including, but not limited to, such aspects as follows.

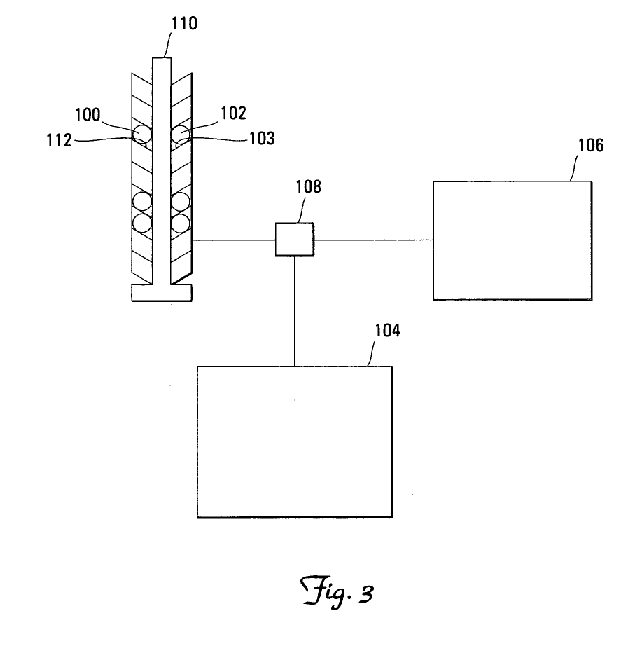

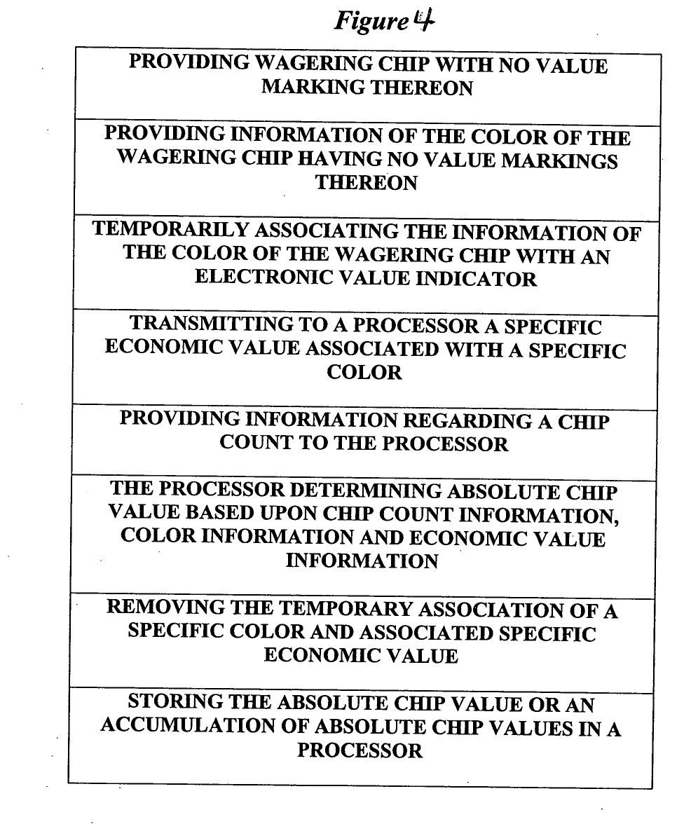

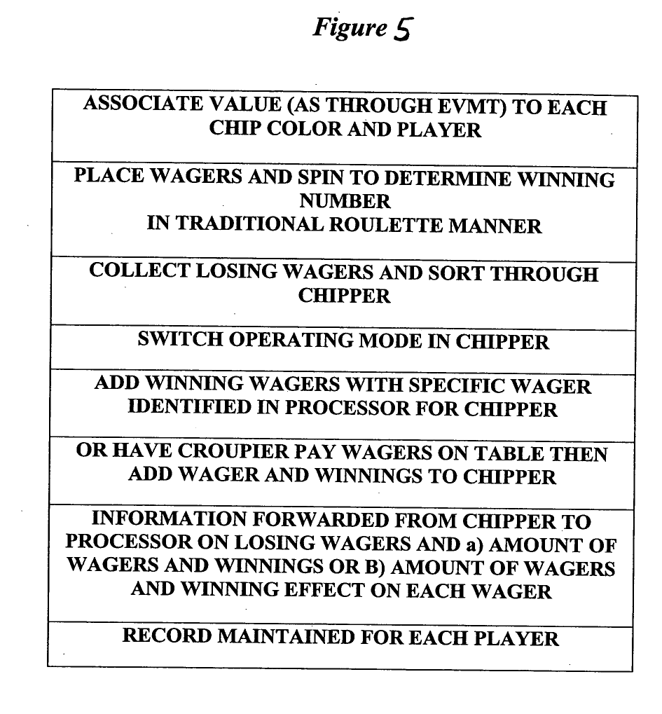

A system as shown in FIG. 3 is provided for evaluating revenue characteristics at a roulette table. The system may comprise
a) wagering chip value association marker 100 comprising a chip board that can be positioned adjacent to a colored casino wagering chip 102, the chip board containing information related to an absolute economic value that will be assigned to a casino wagering chip color or type, that value information being capable of being associated with specific color information;
b) a chip sorter 104 that can count and sort chips according to color of the chips, and count numbers of chips by colors; and
c) a processor 106 in at least one-way informational communication with at least one of a) and b).
   In the system, the wagering chip value association marker may optionally comprise circuitry capable of receiving data from a color sensor (not shown) and being able to forward that data from the color sensor in a format associating a determined color with the absolute economic value, and the color sensor may be part of the marker. Alternatively, each chip color may be pre-assigned to one of the chip receiving compartments 102 so that each color is associated with a channel in the chipper, as well as a value assigned by the marker acceptor track 100. The marker may have transmission capability for the value information and for both value information and chip color information. The marker may have information transmission capability ultimately to at least one of b) and c) for chip value information or for at least one of the main processor 106 and the chipper 104 either directly or through a network connection. The signals may be routed through a U.S.B. serial adaptor 108 prior to being connected to a U.S.B. port in the computer 106.

The technology described herein also includes a system for evaluating value flow at a roulette table comprising an electronic value marking tree 110 comprising chip boards 100 containing information related to an absolute economic value that can be assigned to a wagering chip 102, a receptor 103 for a wagering chip that informationally associates a wagering chip with at least one single chip board 100 containing information related to an absolute economic value, a color identifier, a processor 106 and an informational communication component in the electronic value marking tree 110 having external communication capability to the processor. The chip boards 100 containing information related to an absolute value may be removable from and insertable into marker receptors 112 on the marking tree 110, and each marker receptor 112 may have an associated chip receptor 103. The information communication component may be communicatively linked to the color identifier and to the chip boards containing information related to an absolute value, and the information communication component is capable of communicating information from the color identifier and the at least one single chip board so that an absolute economic value is associated with an individual color of wagering chip, and in one embodiment the external communication component is a wireless communication component (not shown). The information communication component may be communicatively linked to the color identifier and to the chip boards containing information related to an absolute value, and the information communication component is capable of communicating information from the color identifier and the at least one single chip board so that an absolute economic value is associated with an individual color of wagering chip. The external communication component may be a wired connection, a network connection or a wireless communication component and each wagering chip acceptor may be able to receive only a single wagering chip at a time. In one embodiment, the information communication component is in ultimate information communication with a chip sorter that sorts and counts wagering chips by color.

Another described technology includes a method for tracking value movement represented by colored chips in a roulette game comprising temporarily assigning value to individually colored wagering chips by positioning the individually colored wagering chip in a value determining element adjacent to an electronic source of value information within the value determining element, sending color and/or position information from the wagering chip and value information from the value determining element to a processor, and basing valuation of wagering chips that are counted in a finite period of time upon both the color information and value information assigned to that color. In one embodiment, pairs of slots 103, 112 are provided in the value determining element 110, a colored wagering chip 102 is inserted into a first slot 103 of a pair of slots comprising a wagering chip acceptor, the electronic source comprises a chip board 100 having electronic information and is inserted into a second slot 112 of an opposed pair of slots within the value determining element 110 that comprises a chip board receptor, and color information is obtained from either the assigned position of the wagering chip acceptor or a color reader and value information is obtained from the electronic source to form color-value information, and that color-value information is transmitted to at least one device external to the electronic source. Transmitted color-value information is sent to a data processor 106 that has access to information of total numbers of chips according to color. The data processor 106 calculates a value of wagering chips for a particular color based upon the color-value information and the total number of chips of a color included in the color-value data.

Another described technology as shown in Diagrams 4 and 5 includes a method of assessing transactions at a roulette table comprising:
d) temporarily assigning a specific value to wagering chips based upon the color of the wagering chips;
e) providing knowledge of the specific value of wagering chips based upon the color of the wagering chips to a processor;
f) after determination of a winning number after a spin in a game of roulette, placing losing wagers in a chip sorter that identifies numbers of chips and colors of chips;
g) forwarding numbers and colors of chips from at least losing wagers to the processor;
h) placing winning wagers after the spin in a game of roulette into the chip sorter that identifies numbers of chips and colors of chips;
i) forwarding numbers and colors of chips from winning wagers to the processor; and
j) the processor determining at least amounts wagered with individual color chips and amounts of winning wagers placed for individual color chips during roulette play after the spin in a game of roulette.
   In one example of the method, the chips from specific winning wagers (e.g., color, line, column, specific number, two numbers, etc., or wagers based upon known equal odds such as color and even or odd) are placed into the chip sorter according to specific wagers made with the specific winning wagers and the processor may calculate an amount of winnings on those specific winning wagers according to stored payout odds available for those specific winning wagers. This function is best handled by a player tracking package that associates wagering activity with the identity of a player. In another format, the croupier provides a payout at odds with chips onto winning wagers on a roulette table, and both the chips paid on winning odds and chips wagered on specific winning wagers are placed into the chip sorter that identifies numbers of chips and colors of chips from both the winning wagers and the payouts to the processor. In another format that utilizes player tracking, the croupier inputs data into the chip sorter for various batches of wagering chips to identify either the specific winning wagers made, the odds on the specific winning wagers made, cash wagers, credit wagers, check wagers, other wagers or both the specific winning wagers made and the odds on the specific winning wagers made. In another format, as described above, the chip sorter runs through a sequence of indicated different wagers with different payout odds, and a croupier provides chips from specific winning wagers to the chip sorter according to the indicated different wagers. The processor may determine a total number of chips to be returned to a winning player based upon the color of chips, the number of chips wagered as winning wagers, and odds to be paid on the winning wagers or other useful information. This total number of chips to be returned to a player is displayed to at least the croupier and likely to players also. The sequence of indicated different wagers may be displayed on a display screen or display panel. The chip sorter may move through the sequence of indicated different wagers upon input from the croupier. The method may operate under different modes of information transmission that are provided from the chip sorter to differentiate between losing wagers and winning wagers.

Another disclosed technology comprises apparatus for assessing transactions at a roulette table comprising:
k) a roulette table comprising a wagering area, a roulette wheel, and a ball indicator;
l) a chip sorter capable of sorting chips and counting chips according to color; and
m) a processor;
   the chip sorter being able to operate in at least two distinct modes, a first mode comprising sorting and counting chips from losing wagers by color and reporting on losing chip counts by color to a processor, and a second mode comprising counting chips from winning wagers by color and reporting on winning chip counts by color to a processor. A third mode would count total wagers. The second mode may also include reported information on payout odds for specific winning wagers for specific numbers of chips. The second mode may also include reported information comprising a number of chips wagered and a number of chips paid for each color on winning wagers. In the apparatus, the croupier may input information (e.g., through a button, voice operated, laser wand activated, touch screen or switch panel, by way of non-limiting examples) for indicating a value factor selected from the group consisting of specific wager made with a batch of chips inserted into the chip sorter, payout odds to be paid on a batch of chips inserted into the chip sorter, and both the specific wager made with a batch of chips inserted into the chip sorter and payout odds to be paid on a batch of chips inserted into the chip sorter. The chip sorter itself may automatically or upon instruction identify in sequence information indicating a value factor selected from the group consisting of specific wager made with a batch of chips inserted into the chip sorter, payout odds to be paid on a batch of chips inserted into the chip sorter, and both the specific wager made with a batch of chips inserted into the chip sorter and payout odds to be paid on a batch of chips inserted into the chip sorter. The wagering chip value association marker may be used to indicate value for specific colors of wagering chips, and the chip value association marker comprises a chip board that can be positioned adjacent to a colored casino wagering chip, the chip board containing information related to an absolute economic value that will be assigned to a casino wagering chip, that value information being capable of being associated with specific color information.

1-46. (canceled)

47. A system for evaluating revenue characteristics at a roulette table comprising a
a) wagering chip value association marker comprising a chip board that can be positioned adjacent to a colored casino wagering chip, the chip board containing information related to a temporary absolute economic value that will be assigned to a casino wagering chip, that value information being capable of being associated with specific color information;
b) a chip sorter that can count and sort chips according to color of the chips, and count numbers of chips by colors; and
c) a processor in at least one-way informational communication with at least one of a) and b).

48. The system of claim 47 wherein the wagering chip value association marker comprises a circuitry capable of receiving data from at least a position of one chip receiving compartment or a color sensor and being able to forward that data in a format associating a determined color with the absolute economic value.

49. The system of claim 48 wherein the marker is part of the color sensor, the marker has transmission capability for the value information, or the marker has both information transmission capability and chip color information.

50. A system for evaluating value flow at a roulette table comprising an electronic value marking tree comprising a plurality of chip boards each containing information related to an absolute economic value that can be temporarily assigned to a wagering chip color, a receptor for a wagering chip that informationally associates a wagering chip color with at least one single chip board containing information related to a temporary absolute economic value, a processor and an informational communication component in the electronic value marking tree having external communication capability to the processor.

51. The system of claim 50 wherein the chip boards containing information related to an absolute value also contain a color sensor, or the chip boards containing information related to an absolute value are removable from and insertable into marker receptors on the marking tree or each marker receptor has an associated chip receptor.

52. The system of claim 51 wherein the information communication component is communicatively linked to the color identifier and to the chip boards containing information related to an absolute value, and the information communication component is capable of communicating information from the color identifier and the at least one single chip board so that an absolute economic value is associated with an individual color of wagering chip.

53. The system of claim 50 wherein the external communication component is a wireless communication component or each wagering chip acceptor can receive only a single wagering chip at a time.

54. The system of claim 51 wherein the information communication component is in ultimate information communication with a chip sorter that sorts and counts wagering chips by color.

55. A method for tracking value movement in a roulette game comprising temporarily assigning value to individually colored wagering chips by positioning the individually colored wagering chip in a value determining element adjacent to an electronic source of value information within the value determining element, sending at least one of color information from the wagering chip and value information from the value determining element to a processor, and basing valuation of wagering chips that are counted in a finite period of time upon at least the value information assigned to that color.

56. The method of claim 55 wherein pairs of slots are provided in the value determining element, a colored wagering chip is inserted into a first slot of a pair of slots comprising a wagering chip acceptor, the electronic source comprises a chip board having electronic information and is inserted into a second slot of an opposed pair of slots within the value determining element that comprises a chip board receptor, and color information is obtained from the wagering chip acceptor and value information is obtained from the electronic source to form color-value information, and that color-value information is transmitted to at least one device external to the electronic source.

57. The method of claim 56 wherein transmitted color-value information is sent to a data processor that has access to information of total numbers of chips according to color.

58. The method of claim 57 wherein the data processor calculates a value of wagering chips for a particular color based upon the color-value information and the total number of chips of a color included in the color-value data.

59. A method of assessing transactions at a roulette table comprising:
a) assigning a specific value to wagering chips based upon the color of the wagering chips;
b) providing knowledge of the specific value of wagering chips based upon the color of the wagering chips to a processor;
c) after determination of a winning number after a spin in a game of roulette, placing losing wagers in a chip sorter that identifies numbers of chips and colors of chips;
d) forwarding numbers and colors of chips from losing wagers to the processor;
e) placing winning wagers after the spin in a game of roulette into the chip sorter that identifies numbers of chips and colors of chips;
f) forwarding numbers and colors of chips from winning wagers to the processor; and
g) the processor determining at least amounts wagered with individual color chips and amounts of winning wagers placed for individual color chips during roulette play after the spin in a game of roulette.

60. The method of claim 59 wherein chips from specific winning wagers are placed into the chip sorter and the processor determines an amount of winnings on those specific winning wagers according to payout odds available for those specific winning wagers.

61. The method of claim 60 wherein a croupier provides a payout at odds with chips onto winning wagers on a roulette table, and both the chips paid on winning odds and chips wagered on specific winning wagers are placed after the spin in a game of roulette into the chip sorter that identifies numbers of chips and colors of chips from both the winning wagers and the payouts to the processor.

62. The method of claim 61 wherein a croupier inputs data into the chip sorter for various batches of wagering chips to identify either the specific spinning wagers made, the odds on the specific winning wagers made, or both the specific winning wagers made and the odds on the specific winning wagers made.

63. The method of claim 61 wherein the chip sorter runs through a sequence of indicated different wagers with different payout odds, and a croupier provides chips from specific winning wagers to the chip sorter according to the indicated different wagers.

64. The method of claim 61 wherein the processor determines a total number of chips to be returned to a winning player based upon the color of chips, the number of chips wagered as winning wagers, and odds to be paid on the winning wagers.

65. The method of claim 63 wherein the sequence of indicated different wagers is displayed on a display screen or display panel.

66. The method of claim 61 wherein different modes of information transmission are provided from the chip sorter to differentiate between losing wagers and winning wagers.

67. Apparatus for assessing transactions at a roulette table comprising:
h) a roulette table comprising a wagering area, a roulette wheel, and a ball indicator;
i) a chip sorter capable of sorting chips and counting chips according to color; and
j) a processor;
the chip sorter being able to operate in at least two distinct modes, a first mode comprising sorting and counting chips from losing wagers by color and reporting on losing chip counts by color to a processor, and a second mode comprising counting chips from all wagers by color and reporting on all wager chip counts by color to a processor.

68. The apparatus of claim 67 and further comprising a third mode of counting winning wagers by color, wherein the third mode also includes reported information on payout odds for specific winning wagers for specific numbers of chips.

69. The apparatus of claim 68 wherein the third mode includes reported information comprising a number of chips wagered and a number of chips paid for each color on winning wagers.

70. The apparatus of claim 67 and further comprising a data tracking module with a croupier data input, wherein croupier input sources are available for indicating a value factor selected from the group consisting of specific wager made with a batch of chips inserted into the chip sorter, payout odds to be paid on a batch of chips inserted into the chip sorter, and both the specific wager made with a batch of chips inserted into the chip sorter and payout odds to be paid on a batch of chips inserted into the chip sorter.

71. A method for determining player activity in combination with temporarily assigning value to a wagering chip having a significant color characteristic comprising positioning the wagering chip adjacent to a source of value information, sending both color information from the wagering chip and value information from the source to a processor, basing valuation of wagering chips that are counted in a finite period of time upon association of the color information and value information received by the processor, and evaluating player activity by monitoring numbers or values of chips of particular colors associated with specific players.
